(19) United States
(12) Patent Application Publication
(10) Pub. No.: US 2023/0219821 A1
(43) Pub. Date: Jul. 13, 2023

(54) CONDUCTIVE CARBON AEROGEL WITH HIGH SILICON CONTENT FOR SOLID STATE BATTERY ANODE APPLICATIONS

(71) Applicant: Ford Global Technologies, LLC, Dearborn, MI (US)

(72) Inventors: Haibo Zhao, Northville, MI (US); Katherine Avery Vozar, Saline, MI (US); Alper Kiziltas, Sarikamis (TR); Deborah Frances Mielewski, Ann Arbor, MI (US)

(73) Assignee: Ford Global Technologies, LLC, Dearborn, MI (US)

(21) Appl. No.: 17/572,230

(22) Filed: Jan. 10, 2022

(51) Int. Cl. C01B 33/158; H01M 10/36

(52) U.S. Cl. CPC C01B 33/1585; H01M 10/36; H01M 2220/20; C01P 2004/64

(57) ABSTRACT

A composite aerogel material includes a carbonized aerogel defining a 3D porous structure and a silicon-based material dispersed within the 3D porous structure, wherein the silicon-based material includes at least 70% by mass fraction. A method of manufacturing a composite aerogel material includes mixing water, an acrylonitrile monomer, silicon particles, a surfactant, a thermal polymerization initiator, and a solvent and heating as a solution. The solution is quenched, wherein a polyacrylonitrile (PAN) silicon nanoparticle micro bead gel precipitates from the solution. A solvent exchange then occurs to form a silicon-based aerogel material, which is then freeze dried. The silicon-based aerogel material is carbonized to form a composite aerogel material comprising a carbonized aerogel defining a 3D porous structure and a silicon-based material dispersed within pores of the carbonized aerogel.

### FIELD

The present disclosure relates to composite aerogel materials, and more specifically to a carbon-based aerogel material, and methods of manufacturing the same.

### BACKGROUND

The statements in this section merely provide background information related to the present disclosure and may not constitute prior art.

Silicon is a promising material for application in solid-state battery anodes for next generation electric vehicles. However, silicon, when used on its own as the anode material experiences significant volume change (i.e., expansion and contraction) during charge and discharge of the battery. This volume change may lead to cracking in the silicon and reduced performance and retention capability of the battery. Therefore, increased structural stability in battery anode materials to accommodate volume changes during charge and discharge is continually being pursued in electric vehicle application.

The present disclosure addresses these and other issues related to solid-state battery anodes.

### SUMMARY

This section provides a general summary of the disclosure and is not a comprehensive disclosure of its full scope or all of its features.

The present disclosure provides a composite aerogel material comprising a carbonized aerogel defining a 3D porous structure and a silicon-based material dispersed within the 3D porous structure. The silicon-based material comprises at least 70% by mass fraction of the composite aerogel material. In one form, the silicon-based material comprises silicon nanoparticles.

In variations of this composite aerogel material, which may be employed individually or in any combination: the 3D porous structure defines spheres of the carbonized aerogel between about 2 μm to about 5 μm in diameter with pores between about 2 nm to about 50 nm in diameter, and a size of the silicon nanoparticles are between about 2 nm to about 50 nm; the 3D porous structure defines carbonized aerogel fibers between about 2 μm to about 7 μm in length and having a length-to-diameter ratio greater than about 5; the carbonized aerogel is formed from a precursor material selected from the group consisting of polyacrylonitrile, polyolefin, lignin-cellulose, and nylon; and the silicon-based material is selected from the group consisting of pure silicon, silicon oxide, and silicon dioxide.

In another form of the present disclosure, a composite aerogel material consists of a carbonized aerogel defining a 3D porous structure and silicon nanoparticles dispersed within pores of the carbonized aerogel. The silicon nanoparticles comprise at least 70% by mass fraction of the composite aerogel material.

In one form, the 3D porous structure defines spheres of the carbonized aerogel between about 2 μm to about 5 μm in diameter with pores between about 2 nm to about 50 nm in diameter, and a size of the silicon nanoparticles is between about 2 nm to about 50 nm. In another aspect, the 3D porous structure defines carbonized aerogel fibers between about 2 μm to about 7 μm in length and having a length-to-diameter ratio greater than about 5.

In further forms of the present disclosure, a solid-state battery comprises at least one of the composite aerogel materials as described herein. In one form, an energy density of the solid-state battery is greater than about 250 Wh/kg.

In yet another form of the present disclosure, a method of manufacturing a composite aerogel material comprises mixing water, an acrylonitrile monomer, silicon particles, a surfactant, a thermal polymerization initiator, and a solvent and heating in an inert environment as a solution. The solution is quenched, wherein a polyacrylonitrile (PAN) silicon nanoparticle micro bead gel precipitates from the solution. A solvent exchange occurs on the micro bead gel to form a silicon-based aerogel material, which is then freeze dried.

The silicon-based aerogel material is then carbonized in an inert environment to form a composite aerogel material comprising a carbonized aerogel defining a 3D porous structure and a silicon-based material dispersed within pores of the carbonized aerogel. The silicon-based material comprises at least 70% by mass fraction of the composite aerogel material. In one form, the silicon-based material comprises silicon nanoparticles.

In one form, the 3D porous structure defines spheres of the carbonized aerogel between about 2 μm to about 5 μm in diameter with pores between about 2 nm to about 50 nm in diameter, and a size of the silicon nanoparticles is between about 2 nm to about 50 nm. In another aspect, the 3D porous structure defines carbonized aerogel fibers between about 2 μm to about 7 μm in length and having a length-to-diameter ratio greater than about 5.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flow diagram of a method of manufacturing a composite aerogel material according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a composite aerogel material that includes a carbonized aerogel with a 3D porous structure and a silicon-based material dispersed within the 3D porous structure. Advantageously, the silicon-based material comprises at least 70% by mass fraction of the composite aerogel material, which provides an energy density greater than about 250 Wh/kg for solid state battery applications.

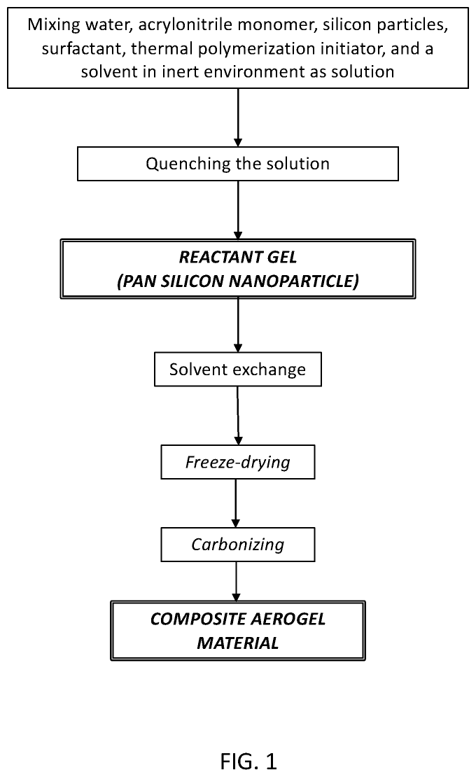

Referring to FIG. 1, a method of forming the innovative composite aerogel material is shown. The method starts with mixing water, an acrylonitrile monomer, silicon particles, a surfactant, a thermal polymerization initiator, and a solvent and heating the mixture in an inert environment as a solution. This step is generally referred to as a synthesis of a microsphere gel and in one form the solution is continually stirred at about 70° C. for about two (2) hours. By way of example, the surfactant may be sodium dodecyl sulfate (SDS), the thermal polymerization initiator may be azobisisobutyronitrile (AIBN), and the solvent may be dimethylformamide (DMF). The solution comprises about 2.5 L of water, about 1.2 L of the acrylonitrile monomer, about 50 grams of the surfactant, and about 1.0 gram of AIBN.

Next, the solution is quenched by adding air and cold water. As a result, a micro bead gel precipitates from the solution, which in one form is a polyacrylonitrile (PAN) silicon nanoparticle micro bead gel. The method further includes undergoing a solvent exchange on the micro bead gel to form a silicon-based aerogel material, freeze drying the silicon-based aerogel material, and carbonizing (at temperatures of about 800° C.-1200° C.) the silicon-based aerogel material in an inert environment to form a composite aerogel material.

The resulting composite aerogel material thus defines a 3D porous structure and a silicon-based material dispersed within pores of the carbonized aerogel, wherein the silicon-based material comprises at least 70% by mass fraction of the composite aerogel material.

In one form of the present disclosure, the silicon-based material comprises silicon nanoparticles. The silicon nanoparticles in one form have a size between about 2 nm to about 50 nm. Further, the silicon-based material in one form is pure silicon. In other forms, the silicon-based material may be silicon oxide or silicon dioxide, among other silicon-based materials. However, for the solid state battery application, pure silicon will provide the highest energy density.

Regarding the specific 3D porous structure of the composite aerogel material, the structure defines spheres of the carbonized aerogel between about 2 μm to about 5 μm in diameter with pores between about 2 nm to about 50 nm in diameter, and a size of the silicon nanoparticles are between about 2 nm to about 50 nm. In another form, the 3D porous structure defines carbonized aerogel fibers between about 2 μm to about 7 μm in length and having a length-to-diameter ratio greater than about 5.

By way of non-limiting example, microspheres may be formed from precipitation of the emulsion polymerization. By way of another non-limiting example, the carbonized aerogel fibers may be formed by dissolving polyacrylonitrile (PAN) in a solvent, such as hexane, mixed with silicon nanoparticles to form a mixture. The mixture may then be spun into fibers by electrospinning. The resulting fibers may then undergo the solvent exchange and carbonization process as described previously.

In one form, the carbonized aerogel is formed from a polyacrylonitrile precursor. In other forms, the precursor may be, by way of example, polyolefin, lignin-cellulose, or nylon, among others.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A composite aerogel material comprising:
a carbonized aerogel defining a 3D porous structure; and
a silicon-based material dispersed within the 3D porous structure,
wherein the silicon-based material comprises at least 70% by mass fraction of the composite aerogel material.

2. The composite aerogel material according to claim 1, wherein the silicon-based material comprises silicon nanoparticles.

3. The composite aerogel material according to claim 2, wherein the 3D porous structure defines spheres of the carbonized aerogel between about 2 μm to about 5 μm in diameter with pores between about 2 nm to about 50 nm in diameter, and a size of the silicon nanoparticles are between about 2 nm to about 50 nm.

4. The composite aerogel material according to claim 1, wherein the 3D porous structure defines carbonized aerogel fibers between about 2 μm to about 7 μm in length and having a length-to-diameter ratio greater than about 5.

5. The composite aerogel material according to claim 1, wherein the carbonized aerogel is formed from a precursor material selected from the group consisting of polyacrylonitrile, polyolefin, lignin-cellulose, and nylon.

6. The composite aerogel material according to claim 1, wherein the silicon-based material is pure silicon.

7. The composite aerogel material according to claim 1, wherein the silicon-based material is selected from the group consisting silicon oxide and silicon dioxide.

8. A solid-state battery comprising the composite aerogel material according to claim 1.

9. The solid-state battery according to claim 8, wherein an energy density of the solid-state battery is greater than about 250 Wh/kg.

10. A composite aerogel material consisting of:
a carbonized aerogel defining a 3D porous structure; and
silicon nanoparticles dispersed within pores of the carbonized aerogel,
wherein the silicon nanoparticles comprise at least 70% by mass fraction of the composite aerogel material.

11. The composite aerogel material according to claim 10, wherein the 3D porous structure defines spheres of the carbonized aerogel between about 2 to about 5 μm in diameter with pores between about 2 nm to about 50 nm in diameter, and a size of the silicon nanoparticles is between about 2 nm to about 50 nm.

12. The composite aerogel material according to claim 10, wherein the 3D porous structure defines carbonized aerogel fibers between about 2 μm to about 7 μm in length and having a length-to-diameter ratio greater than about 5.

13. The composite aerogel material according to claim 12, wherein a size of the silicon nanoparticles is between about 2 nm to about 50 nm.

14. The solid-state battery according to claim 12, wherein an energy density of the solid-state battery is greater than about 250 Wh/kg.

15. A solid-state battery comprising the composite aerogel material according to claim 10.

16. A method of manufacturing a composite aerogel material, the method comprising:
mixing water, an acrylonitrile monomer, silicon particles, a surfactant, a thermal polymerization initiator, and a solvent and heating in an inert environment as a solution;
quenching the solution, wherein a polyacrylonitrile (PAN) silicon nanoparticle micro bead gel precipitates from the solution;
undergoing a solvent exchange on the micro bead gel to form a silicon-based aerogel material;
freeze drying the silicon-based aerogel material; and
carbonizing the silicon-based aerogel material in an inert environment to form a composite aerogel material comprising:
a carbonized aerogel defining a 3D porous structure; and
a silicon-based material dispersed within pores of the carbonized aerogel,
wherein the silicon-based material comprises at least 70% by mass fraction of the composite aerogel material.

17. The method according to claim 16, wherein the silicon-based material comprises silicon nanoparticles.

18. The method according to claim 17, wherein the 3D porous structure defines spheres of the carbonized aerogel between about 2 μm to about 5 μm in diameter with pores between about 2 nm to about 50 nm in diameter, and a size of the silicon nanoparticles are between about 2 nm to about 50 nm.

19. The method according to claim 17, wherein the 3D porous structure defines carbonized aerogel fibers between about 2 μm to about 7 μm in length and having a length-to-diameter ratio greater than about 5.

20. The method according to claim 19, wherein a size of the silicon nanoparticles is between about 2 nm to about 50 nm.
